(19) United States
(12) Patent Application Publication
(10) Pub. No.: US 2015/0083039 A1
(43) Pub. Date: Mar. 26, 2015

(54) COATING APPARATUS

(71) Applicant: NITTO DENKO CORPORATION, Osaka (JP)

(72) Inventors: Yoshihiro Kitamura, Ibaraki-shi (JP); Hiroshi Matsuo, Ibaraki-shi (JP); Akira Saki, Ibaraki-shi (JP)

(73) Assignee: NITTO DENKO CORPORATION, Osaka (JP)

(21) Appl. No.: 14/559,064

(22) Filed: Dec. 3, 2014

Related U.S. Application Data
(63) Continuation of application No. PCT/JP2013/064603, filed on May 27, 2013.

(30) Foreign Application Priority Data
Jun. 4, 2012 (JP) 2012-126750

(51) Int. Cl. B05C 9/12; B05C 13/00

(52) U.S. Cl. CPC B05C 9/12; B05C 13/00
USPC 118/68

(57) ABSTRACT

Coating apparatus including a supply zone having a supply roll that continuously feeds out a long belt-shaped web, a coating zone having a coating part that applies a coating liquid to a single side of the web fed out from the supply roll, a drying zone that dries a coating liquid film applied to the web to form a coating film, and a winding zone having a winding roll that takes up the web with the coating film by winding. The coating zone forms an entire single coating unit in which one or more feed rolls and the coating part that applies a coating liquid are arranged in a rectangular-cuboidally delimited space, and the coating unit is configured so that the entry and exit of the web is enabled through any of four imaginary planes of the rectangular-cuboidally delimited space that surround the peripheral surface of the feed roll.

### CROSS REFERENCE TO RELATED APPLICATIONS

This is a continuation application of International Patent Application No. PCT/JP2013/064603 filed May 27, 2013, which claims the benefit of Japanese Patent Application No. 2012-126750, filed Jun. 4, 2012, the full contents of all of which are hereby incorporated by reference in their entirety.

### BACKGROUND

1. Technical Field

The present disclosure relates to a coating apparatus comprising a coating zone where a coating film is continuously formed on a long belt-shaped web, the base material of which is paper, plastic film, metal foil, or the like. In particular, the present disclosure relates to a coating apparatus comprising a coating zone configured so that the path along which a web passes through the coating apparatus, i.e. the path line of a web, can be flexibly changed.

2. Background

As illustrated in FIG. 1, a coating apparatus 101 that continuously forms a coating film on a long belt-shaped web normally comprises a supply zone 103, a coating zone 105, a drying zone 107, and a winding zone 109. The supply zone 103 has a supply roll 111 that continuously feeds out a web T. The coating zone 105 has a coating part 112 that applies a coating liquid to the web T. The drying zone 107 has a drying device 115 that dries the coating liquid which was applied to the web T so as to form a coating film. The winding zone 109 has a winding roll 117 that takes up a web T′ with the coating film by winding.

It can be generally assumed that changes need to be made to coating apparatuses in response to product-related requests from customers. Such changes relate to, for example: the raw material of the product, including the type of web or coating liquid; the number of coatings applied; and the surface to be coated.

To change the raw material of the product, the installation of a coating zone may need to be changed with a different coating part. Moreover, to change the number of coatings applied, the web surface to be coated, or the like—e.g., to change from single-sided surface application to double-sided surface application—the path line may need to be changed for the entire coating apparatus.

However, in the conventional coating apparatus 101, the supply zone 103, the coating zone 105, the drying zone 107, and the winding zone 109 are integrally formed as an entire device. Hence, in the above situation, when the raw material of the product, the number of coatings applied, or the like needs to be changed in response to a new product-related request from a customer, a portion of, or the entire coating apparatus needs to be newly produced or improved to address the request, which is time-consuming and costly. The resulting problem is that it is not possible to promptly respond to a new product-related request from a customer.

A means for improving (or replacing) a part of the coating apparatus, such as a coating part comprised in a coating zone, is disclosed in, e.g., Japanese Laid-Open Patent Application Publication No. H8-281196. In the coating apparatus of Japanese Laid-Open Patent Application Publication No. H8-281196, a plurality of coating tools are made modular so as to enable the ease of replacement thereof.

In the configuration of the coating apparatus of Japanese Laid-Open Patent Application Publication No. H8-281196, coating tools are simply configured modularly so that a plurality of different coating parts are replaceable. However, for example, there is a situation where the web coating method needs to be changed from single-sided surface application to double-sided surface application. To address this situation, the path line of the entire coating apparatus should be changed by effectively using a portion of the coating apparatus—e.g., a coating zone—for single-sided surface coating as a portion of the coating apparatus—e.g., a coating zone—for double-sided surface coating. However, the foregoing is not addressed by the coating apparatus of Japanese Laid-Open Patent Application Publication No. H8-281196.

### SUMMARY

The object according to the present disclosure is to provide a coating apparatus in which a coating zone having a coating part is formed as an entire single coating unit. To address changes of the raw material of the product, the number of coatings applied, the web surface to be coated, or the like, a portion of, or the entire path line of the coating apparatus can be changed flexibly. In particular, the present disclosure is directed to providing a coating apparatus in which a coating zone configured in the coating apparatus prior to changing the path line can be effectively used as-is after the change.

To achieve the above object, the present disclosure mainly provides the following features:
(1) A coating apparatus comprises: a supply zone having a supply roll that continuously feeds out a long belt-shaped web; a coating zone having a coating part that applies a coating liquid to an at least single-sided surface of the web fed out and conveyed from the supply roll; a drying zone that dries a coating liquid film applied to the web so as to form a coating film; and a winding zone having a winding roll that takes up the web with the coating film by winding. The coating zone forms an entire single coating unit in which one or more feed rolls and the coating part that applies a coating liquid are arranged in a rectangular-cuboidally delimited space; and the coating unit is configured so that the entry and exit of the web is enabled through any of four imaginary planes of the rectangular-cuboidally delimited space that surround the peripheral surface of the feed roll.
(2) In the coating apparatus according to (1) above, the delimited space is formed by delimitation with a frame body.
(3) In the coating apparatus according to (1) above, the coating unit has two or more provided rolls, including the one or more feed rolls.
(4) In the coating apparatus according to (3) above, the provided rolls are provided in the coating unit so that the web is brought into contact with at least one feed roll of the one or more feed rolls and so that the surface of the web where the coating liquid film is formed does not contact any of the provided rolls in the coating unit when the web passes through the coating unit.
(5) In the coating apparatus according to (4) above, the at least one feed roll is provided so that the wrap angle between the at least one feed roll and the web is greater than or equal to 5 degrees.
(6) In the coating apparatus according to (3) above, the provided rolls are provided at or near an intersection of imaginary lines drawn in a grid form on a plane including a transversal surface that is orthogonal to the axis lines of the provided rolls.

### BRIEF DESCRIPTION OF DRAWINGS

FIG. 1 is a schematic layout diagram illustrating the conventional coating apparatus.

FIG. 2 is a schematic layout diagram illustrating a coating apparatus according to the present disclosure.

FIG. 3 is an expanded diagram of only the coating zone (coating unit) of the coating apparatus illustrated in FIG. 2.

FIG. 4 is a perspective view illustrating the configuration of the main portion of the coating zone (coating unit) of the coating apparatus according to the present disclosure.

FIGS. 5A and 5B are conceptual diagrams illustrating that in the coating zone (coating unit) comprised in the coating apparatus according to the present disclosure, a provided roll can be moved from intersection X along imaginary line m. FIG. 5A illustrates the state before moving, and FIG. 5B illustrates the state after moving.

FIGS. 6A to 6P are conceptual diagrams illustrating various embodiments of the path lines along which the web T can pass through the coating zone when two provided rolls are provided in the coating zone (coating unit) comprised in the coating apparatus according to the present disclosure.

FIGS. 7A to 7T, FIGS. 8A to 8T, FIGS. 9A to 9T and FIGS. 10A to 10G are conceptual diagrams illustrating various embodiments of the path line along which the web T can pass through two to nine provided rolls provided at any of the intersections of imaginary lines drawn in a grid form in the coating unit comprised in the coating apparatus according to the present disclosure.

FIG. 11 is a schematic layout diagram illustrating another coating apparatus according to the present disclosure, which is an example coating apparatus for single-sided surface application of a web.

FIG. 12 is a schematic layout diagram illustrating another coating apparatus according to the present disclosure, which is an example coating apparatus for double-sided surface application of a web.

FIG. 13 is a schematic layout diagram illustrating another coating apparatus according to the present disclosure. This coating apparatus is one example coating apparatus for single-sided surface application of a web in which a coating unit is used in coating and guide zones.

FIG. 14 is a schematic layout diagram illustrating another coating apparatus according to the present disclosure. This device is one example coating apparatus for double-sided surface application of a web in which a coating unit is used in coating, guide, and laminating zones.

FIG. 15 is a schematic layout diagram illustrating another coating apparatus according to the present disclosure. This apparatus is one example coating apparatus for double-sided surface application of a web in which a coating unit is used for coating, guide, and laminating zones.

FIG. 16 is a schematic layout diagram illustrating another coating apparatus according to the present disclosure. This apparatus is one example coating apparatus for double-sided surface application of a web in which a coating unit is used in coating and laminating zones.

### DETAILED DESCRIPTION

Embodiments of the present disclosure are hereinbelow demonstrated in reference to the drawings.

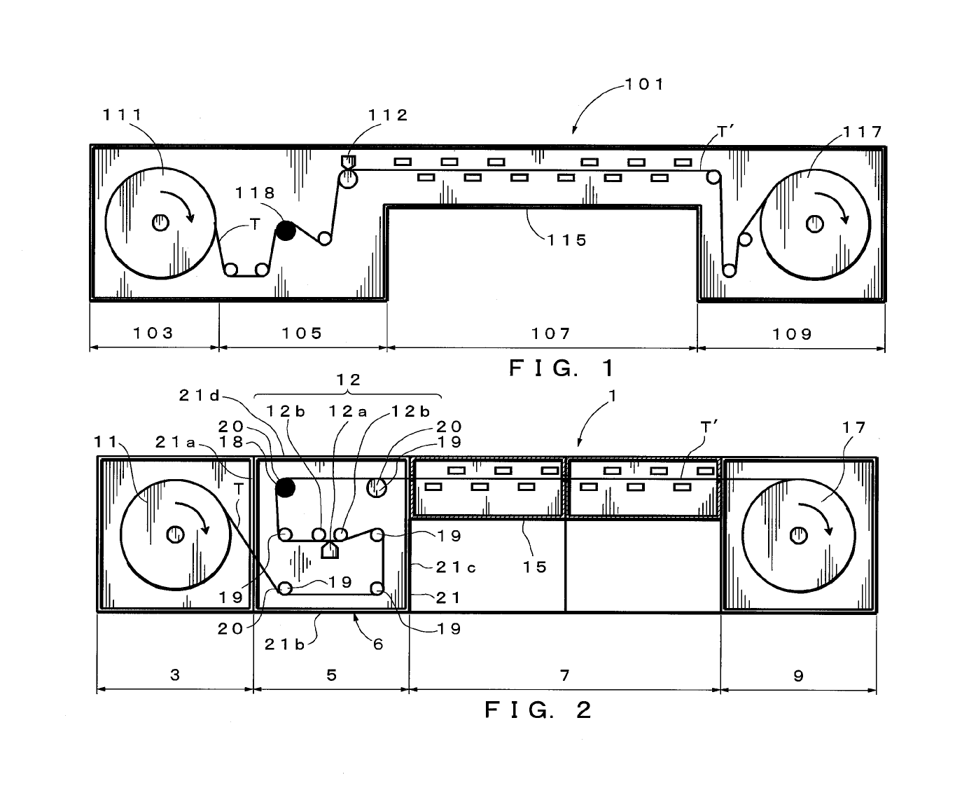

FIG. 2 illustrates an overview of the main portion of a typical coating apparatus according to the present disclosure.

A coating apparatus 1 according to the present disclosure illustrated in FIG. 2 mainly comprises a supply zone 3, a coating zone 5, a drying zone 7, and a winding zone 9.

The supply zone 3 has a supply roll 11 that continuously feeds out a long belt-shaped web T. The web T may comprise a sheet or film material in a long belt shape so that the web can be wound around the supply roll 11 like a coil and so that a coating film can be formed on the surface of the web. There are no particular restrictions with regard to the type of web material, which may include paper, plastic film, and metal foil, for example.

The coating zone 5 has a coating part 12 that applies a coating liquid to form a coating liquid film on an at least single-side of the web T fed out and conveyed from the supply roll 11.

Types of coating devices (coaters) 12a comprising the coating part 12 include for example, die coaters, gravure coaters, kiss coaters, reverse roll coaters, roll knife coaters, and rod coaters. In the present disclosure, there is no particular restriction with regard to the type of the coater 12a.

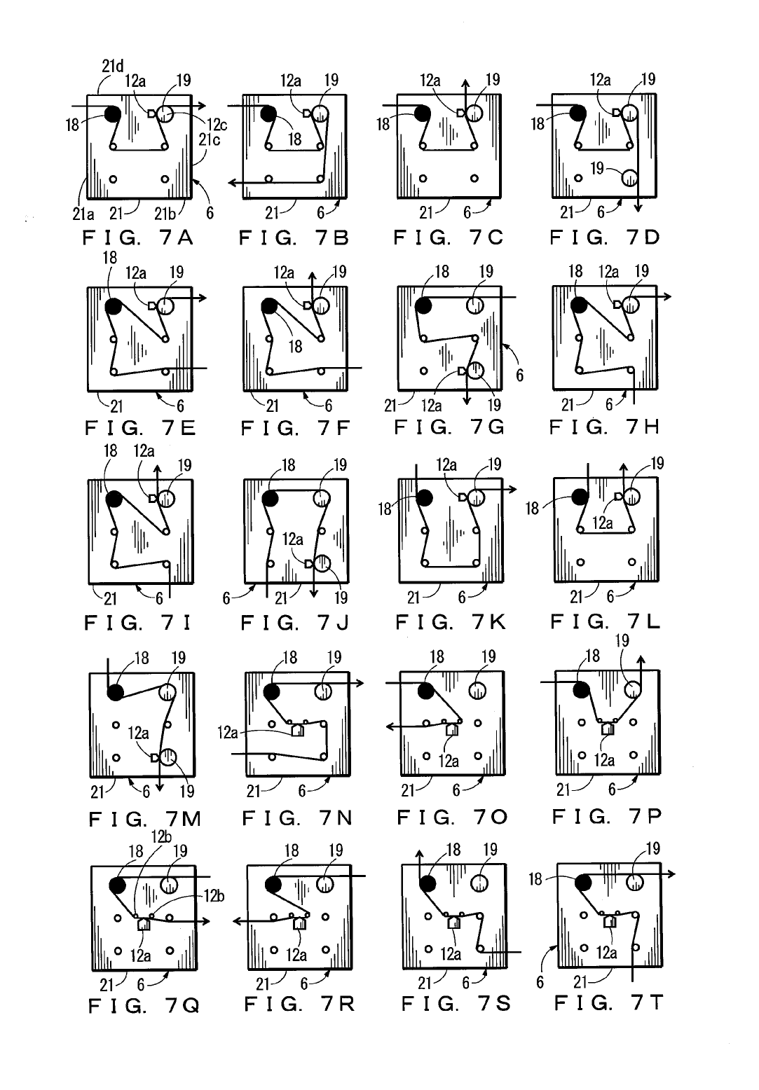

In FIG. 2, the coating part 12 comprises the coater 12a and two tension rolls 12b, 12b. The tension rolls 12b, 12b, which are arranged on the side of the web T other than the side thereof where the coater 12a is arranged, apply a specific tensile force to the web T. For instance, as illustrated in FIG. 7A, the coating part 12 may comprise the coater 12a and one backup roll 12c so that the backup roll 12c is arranged at a position where the backup roll 12c is opposite to the coater 12a with the web T therebetween. In the present disclosure, there is no particular restriction with regard to the configuration of the coating part 12.

As illustrated in FIG. 2, the drying zone 7 has a drying device 15, which dries a coating liquid film applied to the web T to form a coating film. Examples of the drying device 15 include hot-air driers and infrared driers. It is obvious to one of ordinary skill in the art that operation or provision of the drying device 15 is not necessary when the drying zone 7 is of a size sufficient for natural air drying to take place on the continuous line.

Installed in the winding zone 9 is a winding roll 17 that takes up and winds a web T′ having a coating film.

The configuration according to the present disclosure is mainly characterized in that a coating unit 6, which is a single entire modular unit, is formed as the coating zone 5 having the coating part 12. Specifically, in the coating zone 5, provided rolls 20, one or more of which are feed rolls, and the coating part 12 that applies a coating liquid 12 are arranged in a rectangular-cuboidally delimited space 21 in order to form the entire single coating unit 6. In FIG. 2, one feed roll 18 (represented by a black circle) and five guide rolls 19 (represented by a white circle) are the provided rolls. Also, the coating unit 6 is configured so that the exit or entry of the web T is enabled through any of four imaginary planes 21a to 21d that surround the peripheral surface of the feed roll 18. By employing this configuration, the path line can be flexibly changed for a portion of, or the entirety of the coating apparatus 1 in response to changes of the raw material of the product, the number of coatings applied, the surface of the web T to be coated, or the like. In particular, the coating apparatus 1 according to the present disclosure can effectively use the coating zone of the coating apparatus prior to the path line change (see FIG. 11) as the coating zone of the coating apparatus after the path line change (see FIG. 12).

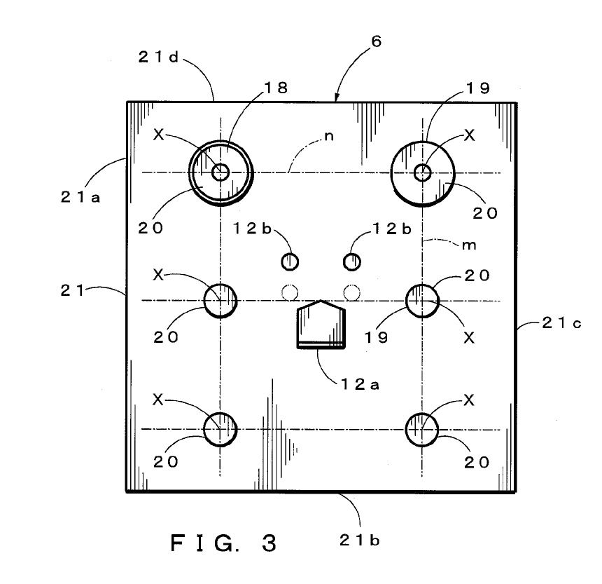

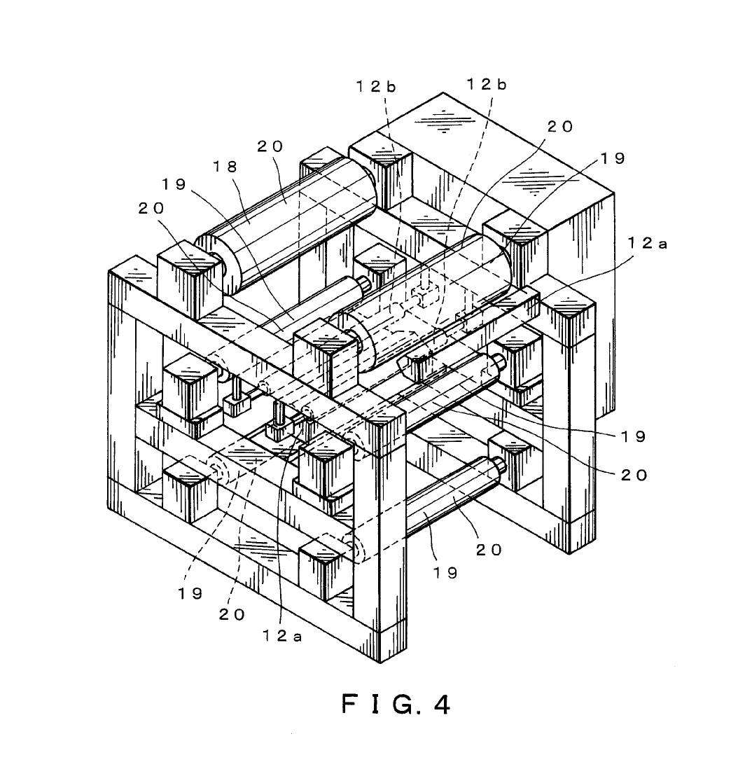

FIG. 3 is an expanded view of only the coating zone (coating unit) of the coating apparatus illustrated in FIG. 2. FIG. 4 is a perspective view of the coating unit 6 comprised in the coating zone 5 according to the present disclosure.

The coating unit 6, in the rectangular-cuboidally delimited space 21 thereof, has the coating part 12 and the provided rolls 20. The rectangular-cuboidally delimited space 21 is a space delimited in a rectangular cuboidal shape so that it is surrounded by six imaginary planes 21a to 21f (the imaginary planes 21e and 21f are not shown). It is preferable that the coating unit 6 comprises a frame body forming a rectangular-cuboidally delimited space. However, six plate covers may be attached to the frame body so as to provide a casing that forms a rectangular-cuboidally delimited space. The frame body may have a rectangular cuboidal shape, but, as illustrated in FIG. 4, as long as the coating part 12 and provided rolls 20 are supported by the frame body and comprised in the rectangular-cuboidally delimited space, the shape of the space does not need to be rectangular cuboidal. The delimited space 21 does not need to be strictly of a rectangular cuboidal shape. However, the coating unit 6 is preferably configured so that the exit or entry of the web T is enabled through any of the four imaginary planes 21a to 21d of the rectangular-cuboidally delimited space 21 that surround peripheral surface of the feed roll 18. As illustrated in FIG. 3, on a plane containing a transversal plane orthogonal to the axis lines of the provided rolls, it is preferable to arrange the four imaginary planes 21a to 21d in a manner such that the rolls are positioned vertically symmetrical, horizontally symmetrical, or vertically and horizontally symmetrical.

In particular, it is preferable that the coating unit 6 comprises a frame body surrounding the rectangular-cuboidally delimited space 21 and that, as illustrated in FIG. 3, the provided rolls 20 are provided at or near intersections X of imaginary lines m and n in a grid pattern. It is also preferable that the provided rolls 20 are placed at the intersections X of the coating unit 6 so as to be vertically or horizontally symmetrical.

In the foregoing configuration, the coating unit 6 can be rotated by 180° in the vertical direction or 90°, 180°, or 270° in the horizontal direction. Alternatively, the coating units 6 can be stacked in a plurality of levels for use. As a result, the path line can be flexibly changed in the coating zone 5 as well as in the entire coating apparatus 1, thereby achieving effective use of the coating unit 6 and space-saving installation of the coating apparatus 1.

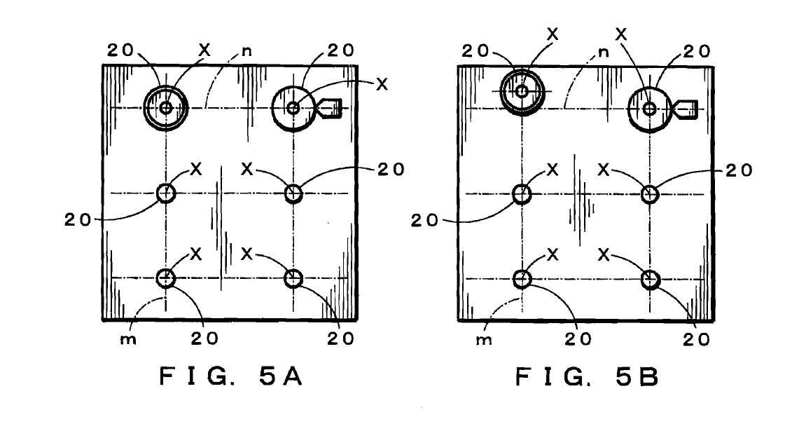

As illustrated in FIGS. 5A and 5B, the specific meaning of a location being near the intersection X is that the location on one of the imaginary lines m and n deviates from the intersection by less than 20% of the distance between the provided rolls.

FIGS. 5A and 5B are conceptual diagrams illustrating that a provided roll can be moved from the intersection X to another location on the imaginary line m in the coating zone (coating unit) comprised in the coating apparatus according to the present disclosure. FIG. 5A illustrates the status before moving, and FIG. 5B illustrates the status after moving.

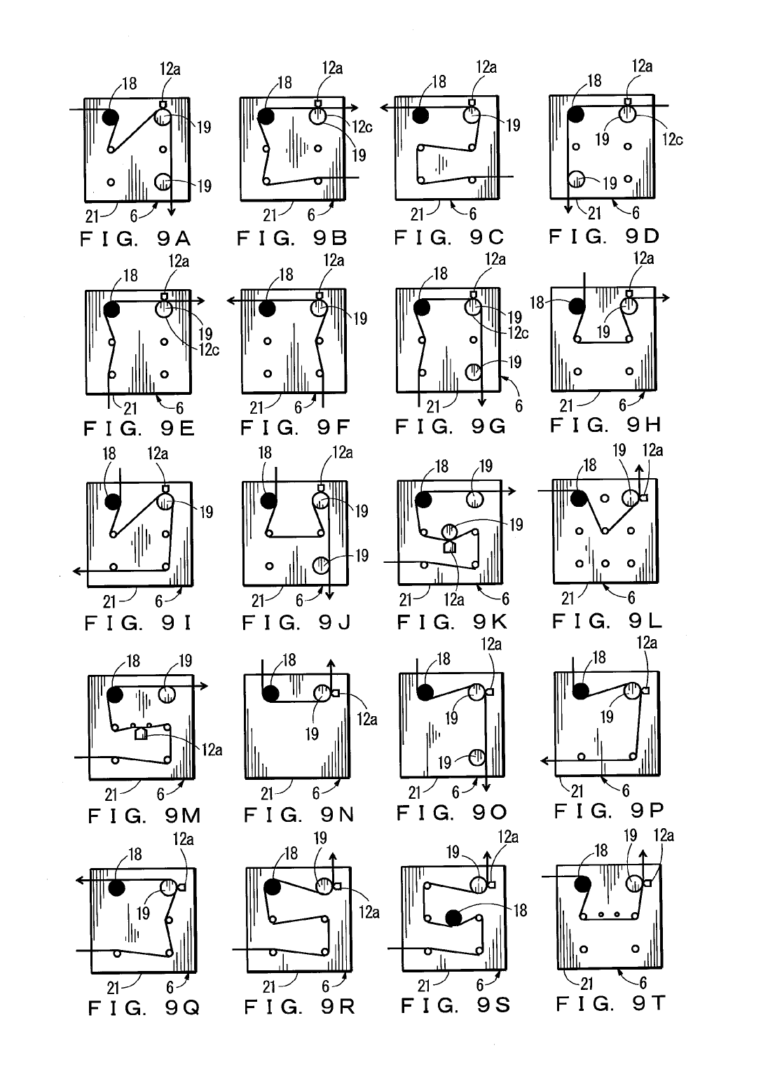

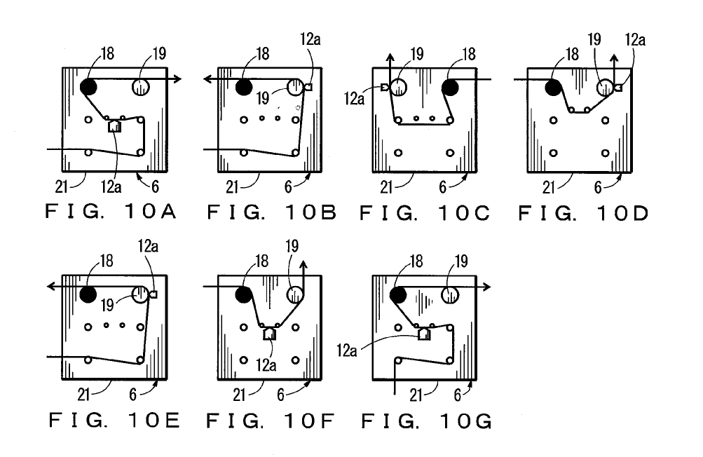

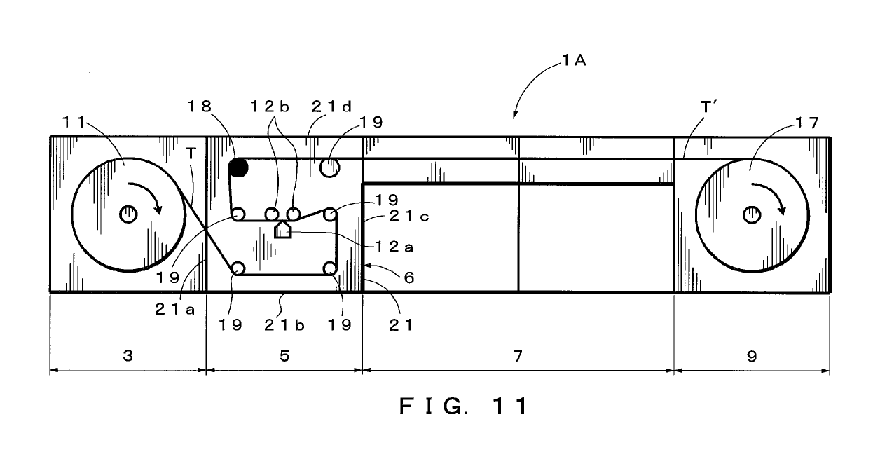

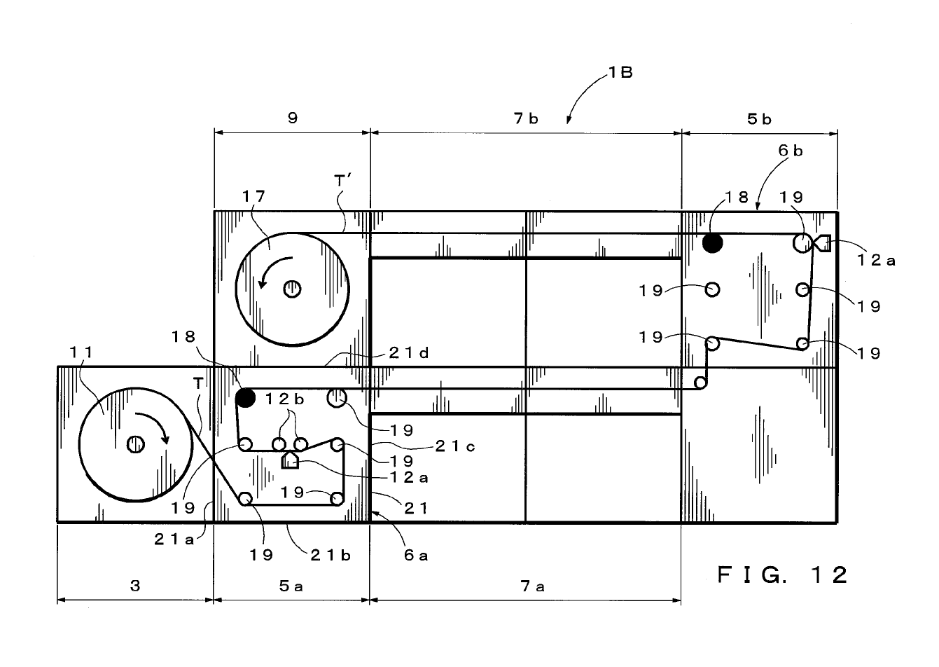

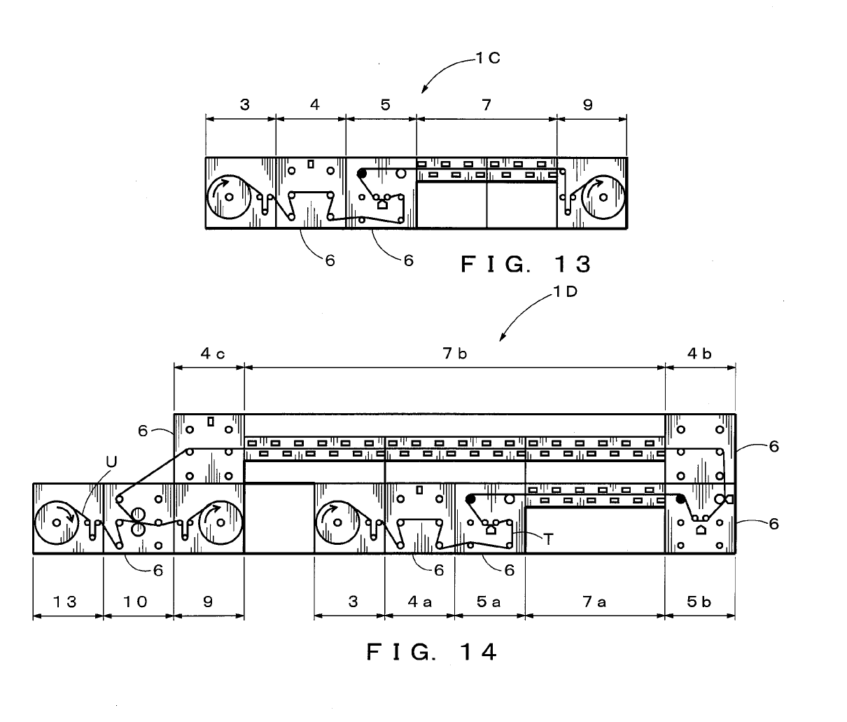

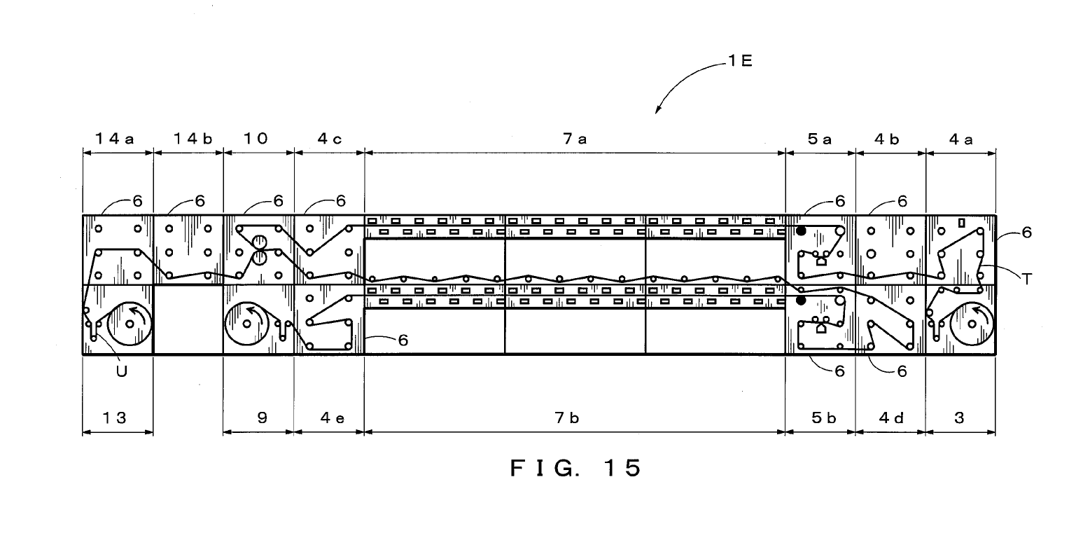

Six provided rolls 20 are arranged in the coating unit 6 illustrated in FIG. 5A. The distance between the provided rolls 20,20 provided on the imaginary line m is, e.g., 400 mm. As illustrated in FIG. 5B, one of the provided rolls 20 in the coating unit 6 in FIG. 5A can be moved along the imaginary line m so as to be located, e.g., 80 mm above the imaginary line n. Specifically, the provided roll can be moved to a location deviating from the intersection by less than 20% of the distance between the provided rolls 20,20. By moving the provided roll 20 away from the intersection X, the wrap angle of the web T with respect to the provided roll can be appropriately adjusted. However, when a malfunction is caused by a decrease in the wrap angle of the web T with respect to the provided roll due to the movement of the provided roll away from the intersection X, the provided roll does not need to be moved from the intersection X. For instance, it is possible to assume that when the feed roll 18 is moved from the intersection X along the imaginary line m so as to be located above the imaginary line n in the coating unit 6 of, e.g., FIGS. 9B, 9D, 9E and 9G, a coating liquid cannot be stably applied to the web T on the path line. The reason is that the aforementioned movement causes a decrease in the wrap angle of the web T with respect to the backup roll 12c.

When all the provided rolls 20 in the coating unit 6 are provided at or near the intersections X, the distance between provided rolls 20,20 is kept constant. Since the path line of the web T in principle runs in the vertical and horizontal directions in the coating unit 6, the smooth exit or entry of the web T is enabled through any of the four planes 21a to 21d of the coating unit 6 that surround the peripheral surfaces of the provided rolls 20 while the tension (tensile force) of the web T is maintained at an appropriate level. Since various path lines of the web T can be employed in the coating unit 6, the same coating unit 6 can be used as any coating unit of a plurality of coating apparatuses. Such use is also applicable to the situation where the path lines need to be changed in the entire coating apparatus.

Guide rollers that can be used as the provided rolls 20 include all kinds of guide rollers such as the feed roll 18, which is a drive roll driven by a motor and the rotating speed thereof is controlled by the motor; a roller that changes the conveyance direction; and a roller that maintains the tension (tensile force) during long-distance conveyance.

Examples of the feed roll 18 include: a suction roll that retains the web T on the roll by suctioning; and a nip roll that cooperates with another roll to hold the web T therebetween.

A specific means for driving the feed roll 18, such as a motor or power supply, is not illustrated in the drawings. Such a drive means may be built into the coating unit 6 or installed as a separate external unit, and can be suitably chosen depending on the requirement.

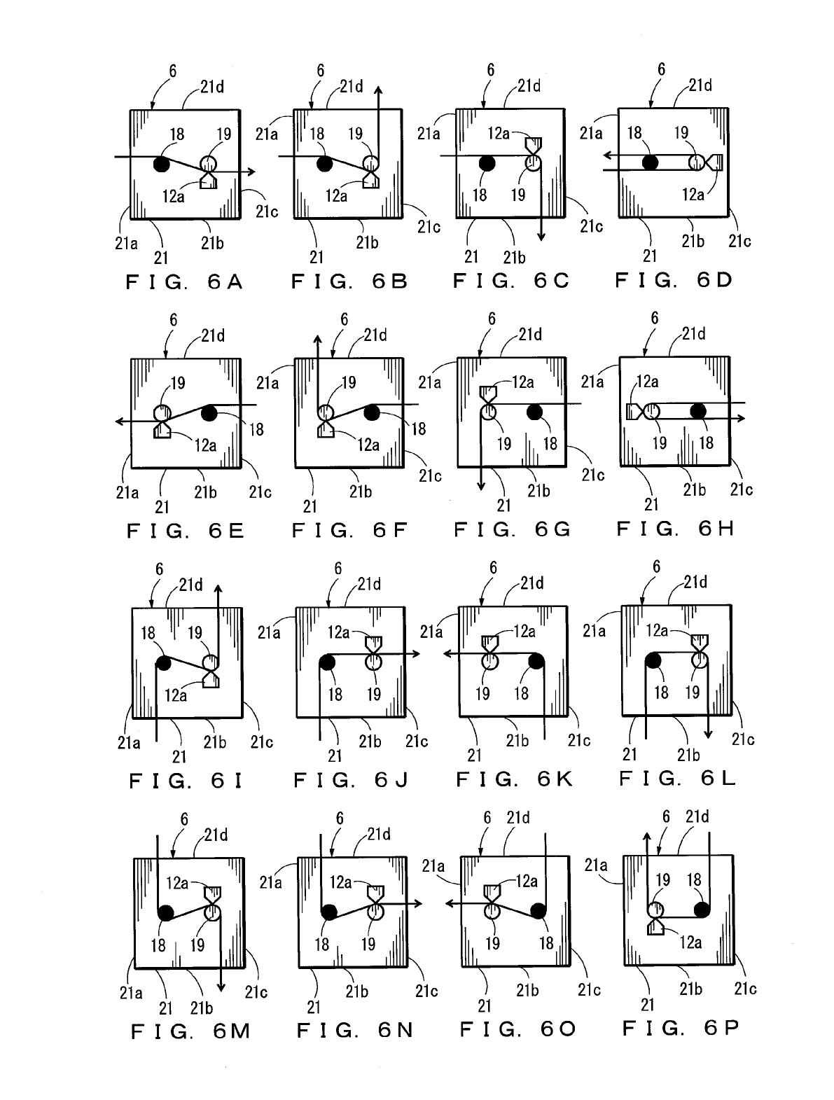

FIGS. 6A to 6P are conceptual diagrams illustrating expected path lines of the web T in the coating unit 6 used according to the present disclosure when the number of the provided rolls 20 in the coating unit 6 is two. With regard to each of FIGS. 6A to 6P, Table 1 depicts which of the imaginary planes 21a to 21d of the delimited space serves as an entry or exit of the web T when it passes through the coating unit 6. The respective coating units 6 of FIGS. 6A to 6P comprise one feed roll 18 represented by a black circle, one guide roll 19 represented by a white circle, and the coater 12a represented by the pentagon. The arrow in the figure denotes the conveyance direction of the web T. Also, “Left”, “Bottom”, “Right”, and “Top” in Table 1 respectively denote “Plane 21a”, “Plane 21b”, “Plane 21c”, and “Plane 21d”, which refer respectively to the imaginary planes 21a to 21d.

TABLE 1

| | | Exit of web from coating |
|---|---|---|
| FIGS. | Entry of web to coating unit | unit |
| FIG. 6A | Left | Right |
| FIG. 6B | | Upper |
| FIG. 6C | | Lower |
| FIG. 6D | | Left |
| FIG. 6E | Right | Left |
| FIG. 6F | | Upper |
| FIG. 6G | | Lower |
| FIG. 6H | | Right |
| FIG. 6I | Lower | Upper |
| FIG. 6J | | Right |
| FIG. 6K | | Left |
| FIG. 6L | | Lower |
| FIG. 6M | Upper | Lower |
| FIG. 6N | | Right |
| FIG. 6O | | Left |
| FIG. 6P | | Upper |

FIGS. 6A to 6P and Table 1 illustrate that the exit or entry of the web T is enabled through any of the four imaginary planes 21a to 21d that surround the peripheral surface of the feed roll 18. When the number of the provided rolls 20 is two, a total of sixteen path lines are possible.

The present disclosure adopts a configuration where the exit or entry of the web T is enabled through any of the four imaginary planes 21a to 21d of the coating unit 6. It is readily appreciated by one of ordinary skill in the art that when the coating unit 6 comprising the coating apparatus according to the present disclosure is used, it is possible to adopt a configuration, e.g., where the exit or entry of the web T is enabled through three, two or one of the surfaces.

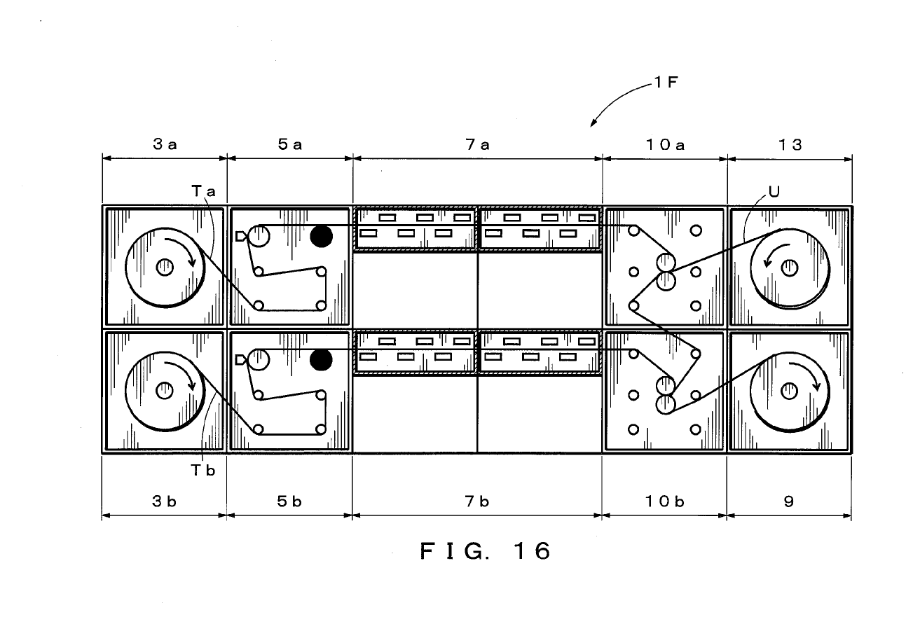

FIGS. 7A to 7T, FIGS. 8A to 8T, FIGS. 9A to 9T and FIGS. 10A to 10G depict a conceptual diagram illustrating various path lines of the web T in the coating unit 6 comprising the coating apparatus according to the present disclosure. The respective coating units 6 in FIGS. 7A to 7T, FIGS. 8A to 8T, FIGS. 9A to 9T and FIGS. 10A to 10G comprise one feed roll 18 represented by the black circle, various types of the guide rolls 19 represented by the white circle, and the coater 12a represented by the pentagon. The arrow in the figure denotes the conveyance direction of the web T. Also, “Left”, “Bottom”, “Right”, and “Top” in Table 2 respectively denote “Plane 21a”, “Plane 21b”, “Plane 21c”, and “Plane 21d”, which refer respectively to imaginary planes 21a to 21d.

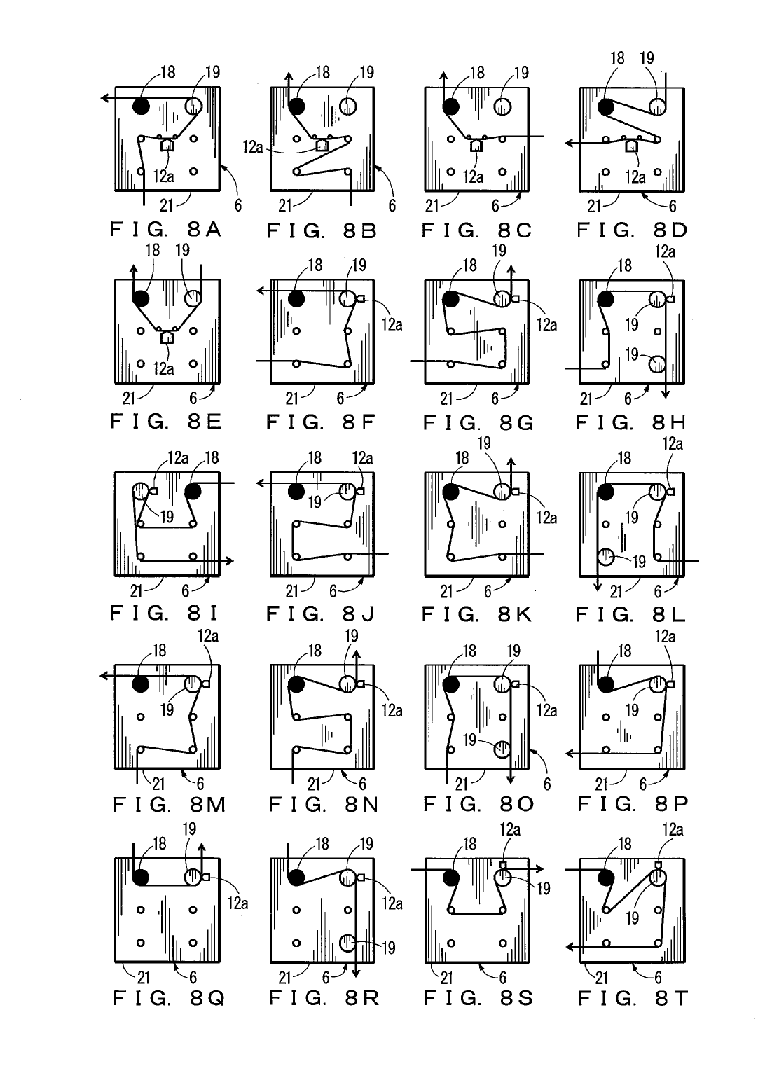

TABLE 2

| | Entry of web to | Exit of web from |
|---|---|---|
| FIGS. | coating unit | coating unit |
| FIGS. 7A, 7N, 8S, 9K, 9M and 10A | Left | Right |
| FIGS. 7C, 7P, 8G, 9L, 9R, 9S, 9T, | | Upper |
| 10D and 10F | | |
| FIGS. 7D, 8H and 9A | | Lower |
| FIGS. 7B, 7O, 8F, 8T, 9Q, 10B | | Left |
| and 10E | | |
| FIGS. 7R, 8J and 9C | Right | Left |
| FIGS. 7F, 7S, 8C, 8K and 10C | | Upper |
| FIGS. 7G, 8L and 9D | | Lower |
| FIGS. 7E, 7Q, 8I and 9B | | Right |
| FIGS. 7I, 8B and 8N | Lower | Upper |
| FIGS. 7H, 7T, 9E and 10G | | Right |
| FIGS. 8A, 8M and 9F | | Left |
| FIGS. 7J, 8O and 9G | | Lower |
| FIGS. 7M, 8R, 9J and 9O | Upper | Lower |
| FIGS. 7K and 9H | | Right |
| FIGS. 8D, 8P, 9I and 9P | | Left |
| FIGS. 7L, 8E, 8Q and 9N | | Upper |

FIGS. 7A to 7T, FIGS. 8A to 8T, FIGS. 9A to 9T and FIGS. 10A to 10G and Table 2 illustrate that when the coating unit 6 formed as the coating apparatus according to the present disclosure is used, a configuration where the exit or entry of the web T is enabled through any of the four imaginary planes 21a to 21d that surround the peripheral surface of the feed roll 18 is possible.

When the coating method, the path line, or the like of the coating unit 6 is changed, changes such as replacement, addition, and like may be appropriately made with regard to the locations and number of the provided rolls 20, including the feed roll 18. To save the labor involved in replacement, etc. of the provided rolls 20, the coating unit 6 may be rotated clockwise by 90°, 180°, or 270° for use thereof. For example, as can be understood by comparing FIG. 7B and FIG. 81, the coating unit 6 can be used in a 180° rotated configuration.

The coating part 12 may be provided at any location so as to be adjusted to the surface of the web T to which a coating liquid is applied. For instance, as can be seen in the coating units of FIG. 7A, FIG. 8F, FIG. 8S and FIG. 9K, the coating part 12 is arranged at locations adjacent to the provided roll 20 on the left, right, upper, and lower sides thereof. The coating liquid may be applied while the web T is pressed against the provided roll 20, which is illustrated as the backup roll 12c. In the coating unit illustrated in FIG. 7Q, coating liquid is applied to the web T while applying a tension on the web T by two tension rolls 12b, 12b.

In the present disclosure, to smoothly and unfailingly convey the web T, it is preferable that the coating unit 6 is configured to have two or more provided rolls 20, including one or more feed rolls 18. In a particularly preferable configuration of the coating unit 6, the web is in contact with at least one feed roll 18 of the aforementioned one or more feed rolls 18, and the provided rolls 20 are provided so that the surface of the web T where a coating liquid film is formed does not contact any of the provided rolls 20 of the coating unit 6 when the web T passes through the coating unit 6. The reason is that this configuration is preferable for preventing occurrence of problems, such as the surface of the web T becoming contaminated by a part of the coating liquid adhered to the peripheral surface of the provided roll 20.

Also, to stably convey the web T, the wrap angle of the at least one feed roll 18 with respect to the web T is preferably 5° or greater, particularly preferably 15° or greater.

FIG. 11 is a schematic layout diagram illustrating the coating apparatus according to the present disclosure when a coating liquid is applied to a single-side of the web T. The coating apparatus 1A illustrated in FIG. 11 comprises the supply zone 3, the coating zone 5, the drying zone 7, and the winding zone 9, wherein the coating zone 5 is formed as the modular coating unit 6.

The coating apparatus 1A is arranged so that the components thereof are horizontally aligned in the following order: the supply zone 3, the coating zone 5 (coating unit 6), the drying zone 7, and the winding zone 9. Along the path line, the web T passes through the components of the coating apparatus 1A in the following order: the supply zone 3, the coating zone 5 (coating unit 6), the drying zone 7, and the winding zone 9, so that a coating liquid can be applied to a single-side of the web T.

FIG. 12 is a schematic layout diagram illustrating the coating apparatus according to the present disclosure when a coating liquid is applied to both sides of the web T. The coating apparatus 1B according to the present disclosure illustrated in FIG. 12 comprises: the supply zone 3; two coating zones—i.e., a first coating zone 5a and a second coating zone 5b; two drying zones—i.e., a first drying zone 7a and a second drying zone 7b; and the winding zone 9. The first coating zone 5a and the second coating zone 5b, which are the two coating zones, are formed as the modular first coating unit 6a and the modular second coating unit 6b, respectively.

The coating apparatus 1B is configured in such a manner that zones are divided in two levels: upper and lower levels. The web T fed out from the supply zone 3 at the lower level is conveyed in the following order: the first coating zone 5a (first coating unit 6a) and the drying zone 7a. Thereafter, the web T passes through upper-level components in the following order: the second coating zone 5b (second coating unit 6b) and the second drying zone 7b, and then the web T is wound in the winding zone 9. In this way, a coating liquid can be applied to both sides of the web T.

Although the path lines of the coating apparatuses 1A,1B are different, the coating unit of the coating apparatus 1A or 1B can be employed as the coating unit of the other of the two coating apparatuses. Specifically, the coating unit 6 comprising the coating apparatus 1A for coating a single side can be used as either of the coating unit 6a,6b comprising the coating apparatus 1B for coating both sides. Conversely, one of the coating units 6a,6b comprising the coating apparatus 1B for coating both sides can also be used as the coating unit 6 comprising the coating device apparatus 1A for coating a single side.

An essential subject matter of the coating apparatus 1A according to the present disclosure is that the coating zone 5 is formed as a single coating unit 6. For example, the other zones of the coating apparatus 1A—e.g., the supply zone 3, the drying zone 7, and the winding zone 9—can also be formed as a modular unit as in the case of the coating zone 5. In such a configuration, the coating apparatus can be modified and used as various types of coating apparatuses, e.g., as the coating apparatus, while units comprising the coating apparatus prior to the modification can be effectively used as-is.

The coating apparatus according to the present disclosure uses the coating unit 6 as the coating zone, in principle. However, as illustrated in FIGS. 13 to 16, the coating unit coating unit 6 can be used as the guide zone 4 and a laminating zone 10.

FIG. 13 is a schematic layout diagram illustrating another coating apparatus according to the present disclosure. This coating apparatus is one example of coating apparatuses for coating a single side of a web in which a coating unit is used in coating and guide zones.

A coating apparatus 1C illustrated in FIG. 13 comprises the supply zone 3, the guide zone 4, the coating zone 5, the drying zone 7, and the winding zone 9. The guide zone 4 has guide rolls that guides the web T from one zone to another, e.g., from the supply zone 3 to the coating zone 5, from the coating zone 5 to the drying zone, or from the drying zone 7 to the winding zone 9. The coating zone 5 and the guide zone 4 are each formed of the modular coating unit 6 of the present disclosure.

The coating apparatus 1C is arranged so that components thereof are horizontally aligned in the following order: the supply zone 3, the guide zone 4, the coating zone 5, the drying zone 7, and the winding zone 9. Along the path line of the coating apparatus 1C, the web T passes through components the following order: the supply zone 3, the guide zone 4, the coating zone 5, the drying zone 7, and the winding zone 9, thereby enabling application of a coating liquid to one side of the web T.

FIG. 14 is a schematic layout diagram of another coating apparatus according to the present disclosure. This apparatus is one example coating apparatus for coating both sides of a web in which a coating unit is used in coating, guide, and laminating zones.

A coating apparatus 1D illustrated in FIG. 14 comprises: a first supply zone 3; three guide zones, wherein the three zones are a first guide zone 4a, a second guide zone 4b, and a third guide zone 4c; two coating zones, wherein the two coating zones are a first coating zone 5a and a second coating zone 5b; two drying zones, wherein the two zones are a first drying zone 7a and a second drying zone 7b; the winding zone 9; a second supply zone 13 comprising supply rolls for the web U that feeds out the web U, wherein the web U is a release paper or the like; and the laminating zone 10 comprising a laminator that laminates the web T and the web U.

There are components of the coating apparatus 1D that are formed as the modular coating unit 6 according to the present disclosure. Such components are as follows: the first coating zone 5a and the second coating zone 5b; the three guide zones—i.e., the first guide zone 4a, the second guide zone 4b, and the third guide zone 4c; and the laminating zone 10.

Zones of the coating apparatus 1D are arranged in two levels. In this arrangement, the web T, which has been fed out from the first supply zone 3 at the lower level, passes through components in the following order: the first guide zone 4a, the first coating zone 5a, the first drying zone 7a, and the second coating zone 5b. In turn, the web T passes through upper-level components in the following order: the second guide zone 4b, the second drying zone 7b, and the third guide zone 4c. Thereafter, at the laminating zone 10 at the lower level, the web T is laminated with the web U fed out from the second supply zone 13 that has supply rolls for the web U, and the laminated web is wound in the winding zone 9. In this way, a coating liquid can be applied to both sides of the web T.

FIG. 15 is a schematic layout diagram of another coating apparatus according to the present disclosure. This apparatus is one example coating apparatus for coating both sides of a web in which a coating unit is used in coating, guide, and laminating zones.

A coating apparatus 1E illustrated in FIG. 15 comprises: the first supply zone 3; two coating zones, wherein the two coating zones are a first coating zone 5a and a second coating zone 5b; five guide zones, wherein the five guide zones are a first guide zone 4a, a second guide zone 4b, a third guide zone 4c, a fourth guide zone 4d, and a fifth guide zone 4e; two drying zones, wherein the two drying zones are a first drying zone 7a and a second drying zone 7b; the laminating zone 10; the winding zone 9; the second supply zone 13 that has supply rolls for the web U that feeds out the web U; and two guide zones for the web U, wherein the two guide zones are a sixth guide zone 14a and a seventh guide zone 14b.

There are components of the coating apparatus 1E that are formed as the modular coating unit 6 according to the present disclosure. Such components are as follows: the first coating zone 5a and the second coating zone 5b; the first guide zone 4a, the second guide zone 4b, the third guide zone 4c, the fourth guide zone 4d, and the fifth guide zone 4e; the sixth guide zone 14a and the seventh guide zone 14b; and the laminating zone 10.

Zones of the coating apparatus 1E are arranged in two levels. In this arrangement, the web T, which has been fed out from the first supply zone 3 at the lower level, passes through components in the following order: the first guide zone 4a, the second guide zone 4b, the first coating zone 5a, the first drying zone 7a, and the third guide zone 4c. In turn, in the laminating zone, the web T is laminated with the web U fed out from the second supply zone 13 that has supply rolls for the web U, wherein the web U has passed through the sixth guide zone 14a and the seventh guide zone 14b. The laminated web again passes through the third guide zone 4c and then through zones at the lower level in the following order: the fourth guide zone 4d, the second coating zone 5b, the second drying zone 7b, and the fifth guide zone 4e, and is wound in the winding zone 9. In this way, a coating liquid can be applied to both sides of the web T.

FIG. 16 is a schematic layout diagram of another coating apparatus according to the present disclosure. This apparatus is one example coating apparatus for coating both sides of a web in which a coating unit is used as coating and laminating zones.

A coating apparatus 1F illustrated in FIG. 16 comprises: two supply zones, wherein two supply zones are a first supply zone 3a and a second supply zone 3b, which feed out a web Ta and a web Tb, respectively; two coating zones, wherein the two coating zones are a first coating zone 5a and a second coating zone 5b; two drying zones, wherein the two drying zones are a first drying zone 7a and a second drying zone 7b; the winding zone 9; two laminating zones, wherein the two laminating zones are a first laminating zone 10a and a second laminating zone 10b; and the third supply zone 13 that has supply rolls for the web U that feed out the web U.

There are components of the coating apparatus 1F that are formed as the modular coating unit 6 according to the present disclosure. Such components are as follows: the first coating zone 5a and the second coating zone 5b; and the first laminating zone 10a and the second laminating zone 10b.

Each zone of the coating apparatus 1F is arranged in two levels. In this arrangement, a web Ta, which has been fed out from the first supply zone 3a at the upper level, passes through components in the following order: the first coating zone 5a and the first drying zone 7a. In turn, in the first laminating zone 10a, the web Ta is laminated with the web U fed out from the third supply zone 13 that has supply rolls for the web U. A web Tb, which has been fed out from the second supply zone 3b at the lower level, passes through lower-level components in the following order: the second coating zone 5b and the second drying zone 7b. Thereafter, the web Tb is laminated with the web Ta, which has been laminated with the web U, in the second laminating zone 10b, and then the laminated web is wound in the winding zone 9. In this way, a coating liquid can be applied to both sides of the web T.

According to the present disclosure, a coating zone having an entire coating part is formed as a single coating unit. To address changes of the raw material of the product, the number of coatings applied, the web surface to be coated, or the like, a portion of, or the entire path lines of the coating apparatus can be changed flexibly. In particular, the present disclosure is directed to providing a coating apparatus in which a coating zone comprised in the coating apparatus prior to changing the path lines can be effectively used as-is after the change.

What is claimed is:

1. A coating apparatus comprising:
a supply zone having a supply roll that continuously feeds out a long belt-shaped web;
a coating zone having a coating part that applies a coating liquid to an at least a single side of the web fed out and conveyed from the supply roll;
a drying zone that dries a coating liquid film applied to the web so as to form a coating film; and
a winding zone having a winding roll that takes up the web having the coating film by winding, wherein:
the coating zone forms an entire single coating unit in which one or more feed rolls and the coating part that applies a coating liquid are arranged in a rectangular-cuboidally delimited space; and
the coating unit is configured so that the exit or entry of the web is enabled through any of four imaginary planes of a rectangular-cuboidally delimited space that surround a peripheral surface of the feed roll.

2. The coating apparatus according to claim 1, wherein:
the delimited space is formed by delimitation with a frame body.

3. The coating apparatus according to claim 1, wherein:
the coating unit has two or more provided rolls, including the one or more feed rolls.

4. The coating apparatus according to claim 3, wherein:
the provided rolls are provided in the coating unit so that the web is brought into contact with at least one feed roll of the one or more feed rolls and that the surface of the web where the coating liquid film is formed does not contact any of the provided rolls in the coating unit when the web passes through the coating unit.

5. The coating apparatus according to claim 4, wherein:
the at least one feed roll is provided so that a wrap angle between the at least one feed roll and the web is greater than or equal to 5 degrees.

6. The coating apparatus according to claim 3, wherein:
the provided rolls are provided at or near an intersection of imaginary lines drawn in a grid form on a plane including a transversal surface that is orthogonal to the axis lines of the provided rolls.
